(19) United States
(12) Patent Application Publication
(10) Pub. No.: US 2001/0026882 A1
(43) Pub. Date: Oct. 4, 2001

(54) High-temperature fuel cell with nickel grid, and high-temperature fuel cell stack

(76) Inventors: Wolfgang Thierfelder, Reutte/Tirol (AT); Manfred Wohlfart, Wiesenthau (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/781,835

(22) Filed: Feb. 12, 2001

Related U.S. Application Data
(63) Continuation of application No. PCT/DE99/02436, filed on Aug. 5, 1999.

(30) Foreign Application Priority Data
Aug. 11, 1998 (DE) 198 36 352.4

(51) Int. Cl. H01M 8/10; H01M 8/24

(52) U.S. Cl. 429/30; 429/34; 429/32

(57) ABSTRACT

A nickel grid is arranged on the fuel-gas side of the high-temperature fuel cell, between the bipolar plate and the solid electrolyte. In order to avoid contact problems as the period of operation increases, the bipolar plate is provided with a nickel layer. The nickel grid is secured to the nickel layer in an electrically conducting manner, such as by spot welding.

### CROSS-REFERENCE TO RELATED APPLICATION

This application is a continuation of copending International Application PCT/DE99/02436, filed Aug. 5, 1999, which designated the United States.

### BACKGROUND OF THE INVENTION

### FIELD OF THE INVENTION

The invention lies in the field of fuel cell technology. More specifically, the invention relates to a high-temperature fuel cell in which a nickel grid is arranged between a bipolar plate on the fuel-gas side and a solid electrolyte. The invention further relates to a stack of high-temperature fuel cells which comprises a number of high-temperature fuel cells of this type.

When water is electrolyzed, the electrical current breaks down the water molecules into hydrogen (H₂) and oxygen (O₂). A fuel cell reverses this process. Electrochemical combination of hydrogen (H₂) and oxygen (O₂) to give water is a very effective generator of electricity. This occurs without any emission of pollutants or carbon dioxide (CO₂) if the fuel gas used is pure hydrogen (H₂). Even with an industrial fuel gas, such as natural gas or coal gas, and with air (which may also have been enriched with oxygen (O₂)) instead of pure oxygen (O₂) a fuel cell produces markedly less pollutants and less carbon dioxide (CO₂) than other energy generators which operate using fossil fuels. The fuel cell principle has been implemented industrially in various ways, and indeed with various types of electrolyte and with operating temperatures of from 80° C. to 1000° C.

Depending on their operating temperature, fuel cells are divided into low-temperature, medium-temperature, and high-temperature fuel cells, and these in turn have a variety of technical designs.

In the case of a stack of high-temperature fuel cells composed of a large number of high-temperature fuel cells, there is an upper connector plate which covers the high-temperature fuel cell stack, and under this plate there are, in this order, at least one connector plate, one protective layer, one contact layer, one electrolyte/electrode unit, one further contact layer, one further connector plate, etc.

The electrolyte/electrode unit here comprises two electrodes and a solid electrolyte designed as a membrane arranged between the two electrodes. Each electrolyte/electrode unit here situated between two adjacent connector plates forms, with the contact layers situated immediately adjacent to the electrolyte/electrode unit on both sides, a high-temperature fuel cell, which also includes those sides of each of the two connector plates situated on the contact layers. This type of fuel cell, and other types, are described, for example, by Appleby and Foulkes in the “Fuel Cell Handbook,” 1989, pp. 440-454.

A high-temperature fuel cell of the type mentioned at the outset, in which a nickel grid has been arranged between the bipolar plate situated on the anode side and the solid electrolyte, has been produced and described in DE 40 16 157 A1, for example. The nickel here may be in the form of a nickel grid package which has a relatively thin contact grid and a relatively thick carrier grid.

In a high-temperature fuel cell of this type, direct contact between the nickel grid (or nickel grid package) on the one side and the bipolar plate (interconnector plate) made from CrFe5Y₂O₃1 on the other side has hitherto been preferred. Experiments have now shown that even after a short period of operation, an increased series resistance becomes established on the fuel-gas side. The nickel grid serves on the fuel-gas side (anode side) of the high-temperature fuel cell as a contact between the bipolar plate and the solid electrolyte.

Experiments have now shown that when there is direct connection between the nickel grid and the interconnector plate, even after a short period an intermediate oxide layer arises, composed substantially of chromium oxide. Since this chromium oxide layer has higher resistance than the metals used, the rise in the series resistance is attributed to this oxidation product. The result is an adverse effect on electrical conductivity. The chromium oxide forms at partial pressures of oxygen below 10⁻¹³ Pa (10⁻¹⁸ bar). In general, such partial pressures of oxygen are always present during the operation of the high-temperature fuel cell.

More detailed studies have shown the following: the nickel grid has hitherto been point-attached to the bipolar plate by spot welding. During operation the weld points, and also the contact points, become infiltrated, so to speak, by chromium oxide. This means that there is a poorly conducting oxide layer between the nickel grid and the interconnector plate made from CrFe5Y₂O₃1.

### SUMMARY OF THE INVENTION

The object of the present invention is to provide a a high-temperature fuel cell which overcomes the above-noted deficiencies and disadvantages of the prior art devices and methods of this general kind, and which is improved to avoid the increase in series resistance and to ensure that high performance continues over prolonged periods. Another object on which the invention is based is to provide a stack of high-temperature fuel cells with at least one fuel cell of this type.

The invention is based on the realization that the objects can be achieved if the formation of the chromium oxide layer can be avoided, at least to a substantial extent.

With the above and other objects in view there is provided, in accordance with the invention, a high-temperature fuel cell, comprising:

a bipolar plate made from CrFe5Y₂O₃1 and having a fuel-gas side;

a nickel layer disposed on the fuel-gas side of the bipolar plate;

a nickel grid spot-welded in an electrically conducting manner onto the nickel layer; and

a solid electrolyte disposed on the nickel grid.

In other words, the first-mentioned object is achieved in the high-temperature fuel cell mentioned at the outset by providing the bipolar plate made from CrFe5Y₂O₃1 on the fuel-gas side with a nickel layer and by securing the nickel grid to this nickel layer in an electrically conducting manner, by means of a spot welding process.

Here again the nickel grid may be a nickel grid package made from a relatively thin nickel contact grid and from a relatively thick nickel carrier grid.

In accordance with an added feature of the invention, the nickel layer is a chemically plated coating on the bipolar plate, or an electroplated coating on the bipolar plate.

In accordance with an additional feature of the invention, the nickel layer has a thickness of approximately 20 μm.

With the above and other objects in view there is also provided, in accordance with the invention, a stack of high-temperature fuel cells, comprising a plurality of connector plates stacked on top of one another and an electrolyte disposed therebetween, each two adjacent connector plates forming a high-temperature fuel cell as outlined above.

In relation to the stack of high-temperature fuel cells, the stated object is achieved according to the invention in that the stack has a large number of connector plates arranged one on top of the other with electrolytes situated therebetween, where each two adjacent connector plates form a high-temperature fuel cell of the above-mentioned type.

Improved adhesion of the nickel grid is achieved by way of a thin nickel layer on the bipolar plate (interconnector plate). The two materials of nickel grid and nickel layer have similar compositions, and their quality of connection is therefore very good. During operation of the high-temperature fuel cell practically no infiltration of the weld points or contact points of the grid with a chromium oxide layer takes place. The initial conductivity of the bond of bipolar plate to nickel layer to nickel grid is practically maintained over the entire period of operation.

The coating of the bipolar plate with a thin nickel layer can be carried out by low-cost processes. One way of carrying out the procedure is by deposition using chemical or electroplating methods. The layer thickness here should be about 20 μm. And the fuel-gas side of the bipolar plate should have a full-surface covering of nickel in the region of the grid.

Conventional spot welding processes can be used to establish contact between the nickel grid and the bipolar plate.

The results from stack experiments using static air, studying samples with a nickel layer of the invention, were that stable contact between the nickel grid and the coated CrFe5Y₂O₃1 material existed even when simulating the “start-up”. The connection is metallic in nature. No formation of an intermediate layer made from chromium oxide (Cr₂O₃) could be detected in the samples.

It is regarded as particularly advantageous that the electrical conductivity of the contacts between bipolar plate and nickel layer and nickel grid is practically maintained over the entire period of operation of the high-temperature fuel cell.

Other features which are considered as characteristic for the invention are set forth in the appended claims.

Although the invention is illustrated and described herein as embodied in a high-temperature fuel cell with nickel grid, and stack of high-temperature fuel cells with a cell of this type, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing figures.

### BRIEF DESCRIPTION OF THE DRAWING

FIG. 1 is a sectional view taken through a high-temperature fuel cell; and

FIG. 2 is a diagrammatic illustration of a fuel cell stack.

### DESCRIPTION OF THE PREFERRED EMBODIMENTS

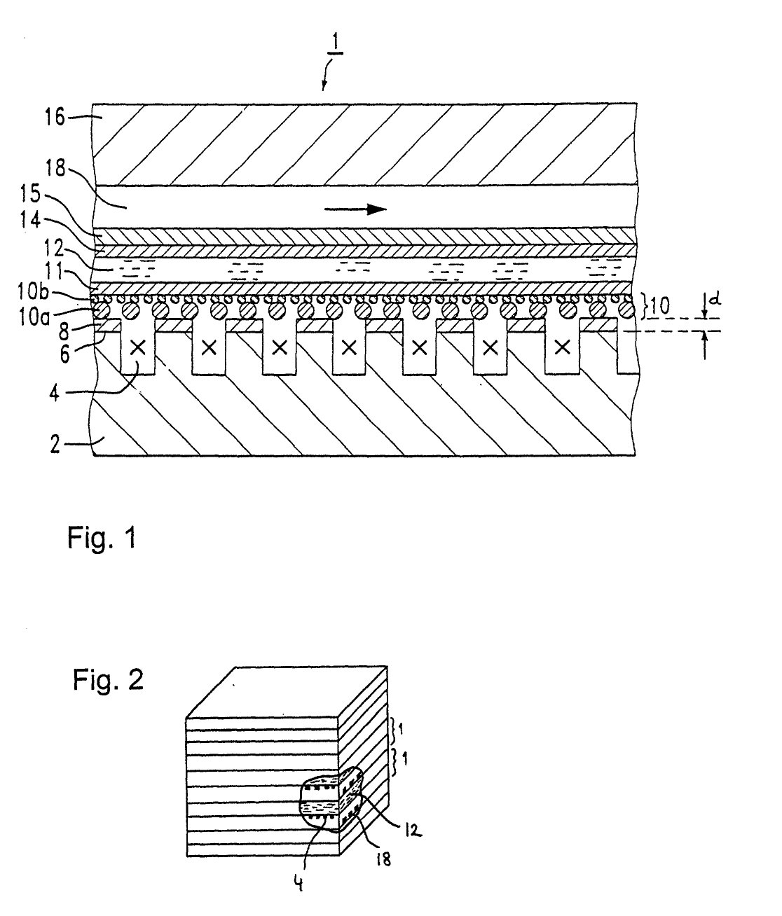

Referring now to the figures of the drawing in detail and first, particularly, to FIG. 1 thereof, there is seen a bipolar plate 2 (interconnector plate made from CrFe5Y₂O₃1) has been formed with a number of channels 4 for operating media. The channels 4 extend perpendicularly to the plane of the paper. The channels 4 are supplied with a combustion gas, such as hydrogen, natural gas, or methane. The lower portion of the high-temperature fuel cell 1 is the anode side. The surface 6 of the bipolar plate 2 has been provided with a thin nickel layer 8. The thickness d of this nickel layer 8 is about 20 μm. A nickel grid 10 has been secured in an electrically conducting manner on the nickel layer 8, by spot welding. The nickel grid 10 here is a nickel grid package composed of a coarse, relatively thick nickel carrier grid 10a and of a fine, relatively thin nickel contact grid 10b. A solid electrolyte 12 adjoins this nickel grid 10 via a thin anode 11. The cathode 14 adjoins the upper side of this electrolyte 12.

Attached to the cathode 14 via a contact layer there is another bipolar plate 16 with a number of channels 18 for operating media, only one of which has been shown. The channels 18 for operating media run parallel to the plane of the paper. During operation they carry oxygen or air.

The unit composed of the cathode 14, the solid electrolyte 11, and the anode 12 is termed an electrolyte-electron unit (MEA, membrane electrode assembly).

The nickel layer 8 shown in the drawing prevents the formation of a chromium oxide layer between the bipolar plate 2 and the nickel grid 10 and therefore ensures good and constant electrical conductivity of the contacts. The fuel cell therefore has low series resistance, which does not increase as the period of operation progresses.

A number of fuel cells 1 of this type may be assembled to give a stack 20 of fuel cells. Additional information with regard to flow distribution within the stack, arrangement of the individual cells, manifold structures, and parametric information may be had, for example, from the above-mentioned publication by Appleby and Foulkes, “Fuel Cell Handbook,” 1989, pp. 440-454.

We claim:

1. A high-temperature fuel cell, comprising:
a bipolar plate made from CrFe5Y₂O₃1 and having a fuel-gas side;
a nickel layer disposed on said fuel-gas side of said bipolar plate;
a nickel grid spot-welded in an electrically conducting manner onto said nickel layer; and
a solid electrolyte disposed on said nickel grid.

2. The high-temperature fuel cell according to claim 1, wherein said nickel layer is a chemically plated coating on said bipolar plate.

3. The high-temperature fuel cell according to claim 1, wherein said nickel layer is an electroplated coating on said bipolar plate.

4. The high-temperature fuel cell according to claim 1, said nickel layer has a thickness of approximately 20 μm.

5. A stack of high-temperature fuel cells, comprising a plurality of connector plates stacked on top of one another and an electrolyte disposed therebetween, each two adjacent said connector plates forming a high-temperature fuel cell according to claim 1.
